(19) United States
(12) Patent Application Publication
(10) Pub. No.: US 2017/0339589 A1
(43) Pub. Date: Nov. 23, 2017

(54) Network-Controlled Terminal Data Call Performance Testing

(71) Applicant: Nokia Solutions and Networks Oy, Espoo (FI)

(72) Inventors: Antti Johannes REIJONEN, Espoo (FI); Hannu Pekka Matias VAITOVIRTA, Espoo (FI)

(73) Assignee: Nokia Solutions and Networks Oy, Espoo (FI)

(21) Appl. No.: 15/523,969

(22) PCT Filed: Nov. 7, 2014
(86) PCT No.: PCT/EP2014/074064

§ 371 Date: May 3, 2017

(51) Int. Cl. H04W 24/08; H04W 24/10

(52) U.S. Cl. CPC H04W 24/08; H04W 24/10

(57) ABSTRACT

There are provided measures for enabling/realizing network-controlled terminal data call performance testing, e.g. controlling terminal data call performance testing using network-related control signaling. Such measures exemplarily include establishment of a network connection between a radio access network entity and at least one terminal for a data call performance test using network-related control signaling, configuration of the data call performance test at the terminal using network-related control signaling, execution of a test data call between the radio access network entity and the at least one terminal over the established network connection, and report and acquisition of results of the data call performance test for the terminal using network-related control signaling.

### FIELD

The present invention relates to network-controlled terminal data call performance testing. More specifically, the present invention relates to measures (including methods, apparatuses and computer program products) for enabling/realizing network-controlled terminal data call performance testing, e.g. controlling terminal data call performance testing using network-related control signaling.

### BACKGROUND

In communication systems, performance testing of various entities at various places within the system deployment is required for monitoring, planning and/or troubleshooting purposes. In existing communication systems (and radio access technologies (RAT)) including LTE, LTE-A, WCDMA, etc., performance test models for the radio access network (RAN), i.e. RAN entities such as BSC, (e)NodeB, BSC, RANC, or the like, exist for verifying that the RAN entity in test conforms to the underlying standard and fulfils the standard quality requirements. In this regard, measurements relating to the performance of RAN entities can be performed in dedicated testing (i.e. laboratory) environments or in live network environments However, no such performance test models are currently specified for terminals such as a user equipment (UE) in existing communication systems (and radio access technologies (RAT)), especially for live network testing. For terminal performance testing, dedicated hardware and/or software is conventionally used so as to perform measurements relating to the performance of terminals in testing (i.e. laboratory) environments only, e.g. using specific performance testing applications running on the terminals. Such conventionally known applications are typically directed to test voice quality. Such voice quality testing is thus typically based on proprietary testing procedures being controlled by scripts running in the testing application on the terminal to be tested and user interaction with the testing application.

Accordingly, currently available approaches for terminal performance testing, especially terminal data call performance testing, are not sufficient in terms of efficiency, convenience, reliability, or the like.

In the following, some example aspects of drawbacks of currently available approaches for terminal performance testing are described.

When there are problems in UE operation/behavior, it is generally difficult to pinpoint the actual cause for such problems within the overall system deployment, i.e. whether the problem is caused by signal conditions, network performance problems, UE performance problems, or the like. For example, if there are suspected problems in power control, it is difficult to say whether the problem is caused by one or more of UE inaccuracy to handle the UE side of power control suboptimal power control parameters, suboptimal power control algorithms in the RAN, e.g. at the BTS or RNC, and/or bugs in the handling of the RAN side of power control.

Further, it is conventionally not feasible or at least difficult to measure a terminal's (data) call performance, i.e. user (data) UP call performance, in a live network environment. This is because the RAN entities do typically not have the possibility to report individual terminal/user call UP call statistics. As one solution in this regard, terminal/user UP call performance has been measured with drive tests, but the results for one terminal/user are highly depended on the cell load, which can vary from time to time. Also, drive tests are expensive to handle and require dedicate test terminals and test/controlling PC, which are capable to generate data and report terminal/user UP call statistics. Herein, the term “test/controlling PC” refers to a test/control-related personal computer, and is generally meant to refer any test/control-related computer or control unit, which can be used for collecting terminal trace measurements and signaling information, as well as generating traffic for test calls (wherein typically terminal trace software is running on such control PC rather than the terminal itself). Yet, newer terminals might not support terminal traces, which will limit the possibilities for drive testing in modern and future communication systems anyway. Further, different terminal traces might give different results, which makes result comparison even more complex and/or less reliable. Still further, drive tests require a lot of time and there are problems in allocating the terminal, because call generators are bulky and require a lot of electricity, and call generators may give misleading results, because terminals are located much closer to each other than real commercial subscribers in live network environments. In this regard, it is to be noted that throughput performance of terminals is very difficult to estimate, unless the higher level application behavior and the used protocol (e.g. TCP streaming) are known. Otherwise, idle periods consisting of polling signaling, etc. can confuse the UP results.

Thus, benchmarking of terminal/user UP call performance has been problematic among different cell or different operators with currently available approaches for terminal performance testing. This is also due to problems in simulating real conditions in testing (i.e. laboratory) environments, e.g. generating uplink interference, building a real-life test environment, especially when either a real core network or a core-network simulator is needed for generating traffic, and reproducing call scenario for customer complaints for a specific terminal to be tested.

Specially referring to performance testing in connection with suspected problems in power control, the following is noted.

A terminal's power control depends on various parameters which deviate for different systems. In LTE, UE UL power control depends e.g. on the UE capability to estimate path loss, the UE capability to fulfil OLPC formulas, the path loss symmetry between DL and UL, higher layer power control parameters for OLPC, the traffic type, and UL and DL resource allocations. In WCDMA, UE UL power control depends e.g. on the UE capability to estimate path loss, the UE capability to fulfil OLPC formulas, higher layer power control parameters for OLPC, the traffic type, and UL and DL resource allocations. In case there are problems in the power control, it is typically very difficult to estimate the actual/root cause, since testing conditions in a live network environment may vary too much when there are many different UE models, different traffic types, etc. are used.

Accordingly, the UE power control is typically tested in a controlled testing (laboratory) environment with only few UE models and few traffic types. In this regard, radio network parameters for UE power control are optimized based on network KPIs and the assumption of their correlation to power control parameters. User data rate, BER and CQI are measured with drive tests via terminal trace software.

Accordingly, there is a demand for enabling/realizing improved terminal data call performance testing, particularly in a live network environment.

### SUMMARY

Various exemplifying embodiments of the present invention aim at addressing at least part of the above issues and/or problems and drawbacks.

Various aspects of exemplifying embodiments of the present invention are set out in the appended claims.

According to an example aspect of the present invention, there is provided a method comprising a method comprising establishing a network connection with at least one terminal for a data call performance test using network-related control signaling, configuring the data call performance test for a terminal at the terminal using network-related control signaling, processing a test data call from the terminal over the established network connection, and acquiring results of the data call performance test for the terminal from the terminal using network-related control signaling.

According to an example aspect of the present invention, there is provided a method comprising a method comprising establishing a network connection with at least one radio access network entity for a data call performance test using network-related control signaling, configuring the data call performance test using network-related control signaling from the radio access network entity, performing a test data call to the radio access network entity over the established network connection, and reporting results of the data call performance test to the radio access network entity using network-related control signaling

According to an example aspect of the present invention, there is provided an apparatus comprising an apparatus comprising a processor, and a memory configured to store computer program code, wherein the processor is configured to cause the apparatus to perform: establishing a network connection with at least one terminal for a data call performance test using network-related control signaling, configuring the data call performance test for a terminal at the terminal using network-related control signaling, processing a test data call from the terminal over the established network connection, and acquiring results of the data call performance test for the terminal from the terminal using network-related control signaling.

According to an example aspect of the present invention, there is provided an apparatus comprising an apparatus comprising a processor, and a memory configured to store computer program code, wherein the processor is configured to cause the apparatus to perform: establishing a network connection with at least one radio access network entity for a data call performance test using network-related control signaling, configuring the data call performance test using network-related control signaling from the radio access network entity, performing a test data call to the radio access network entity over the established network connection, and reporting results of the data call performance test to the radio access network entity using network-related control signaling.

According to an example aspect of the present invention, there is provided an apparatus comprising means for establishing a network connection with at least one terminal for a data call performance test using network-related control signaling, means for configuring the data call performance test for a terminal at the terminal using network-related control signaling, means for processing a test data call from the terminal over the established network connection, and means for acquiring results of the data call performance test for the terminal from the terminal using network-related control signaling.

According to an example aspect of the present invention, there is provided an apparatus comprising means for establishing a network connection with at least one radio access network entity for a data call performance test using network-related control signaling, means for configuring the data call performance test using network-related control signaling from the radio access network entity, means for performing a test data call to the radio access network entity over the established network connection, and means for reporting results of the data call performance test to the radio access network entity using network-related control signaling.

According to an example aspect of the present invention, there is provided a computer program product comprising computer-executable computer program code which, when the program code is executed (or run) on a computer or the program is run on a computer (e.g. a computer of an apparatus according to any one of the aforementioned apparatus-related example aspects of the present invention), is configured to cause the computer to carry out the method according to any one of the aforementioned method-related example aspects of the present invention.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present invention are set out in the following.

By way of exemplifying embodiments of the present invention, network-controlled terminal data call performance testing, e.g. controlling terminal data call performance testing using network-related control signaling, can be enabled/realized. Thus, terminal data call performance testing can be improved, particularly in a live network environment.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating a first example of a procedure according to exemplifying embodiments of the present invention,

FIG. 2 shows a schematic diagram illustrating a second example of a procedure according to exemplifying embodiments of the present invention,

FIG. 3 shows a schematic diagram illustrating a third example of a procedure according to exemplifying embodiments of the present invention,

FIG. 4 shows a schematic diagram illustrating a fourth example of a procedure according to exemplifying embodiments of the present invention, and

FIG. 5 shows a schematic diagram illustrating an example of a structure of apparatuses according to exemplifying embodiments of the present invention.

### DETAILED DESCRIPTION

The present invention is described herein with reference to particular non-limiting examples and to what are presently considered to be conceivable embodiments of the present invention. A person skilled in the art will appreciate that the present invention is by no means limited to these examples and embodiments, and may be more broadly applied.

It is to be noted that the following description of the present invention and its embodiments mainly refers to specifications being used as non-limiting examples for certain exemplifying network configurations and system deployments. Namely, the present invention and its embodiments are mainly described in relation to 3GPP specifications being used as non-limiting examples. As such, the description of exemplifying embodiments given herein specifically refers to terminology which is directly related thereto. Such terminology is only used in the context of the presented non-limiting examples and embodiments, and does naturally not limit the invention in any way. Rather, any other network configuration or system deployment may equally be utilized as long as complying with what is described herein and/or exemplifying embodiments described herein are applicable to it.

Hereinafter, various exemplifying embodiments and implementations of the present invention and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. For sake of clarity and lucidity, all of the exemplary network system configurations and structures are illustrated in a simplified manner.

According to exemplifying embodiments of the present invention, in general terms, there are provided measures and mechanisms for enabling/realizing network-controlled terminal data call performance testing, e.g. controlling terminal data call performance testing using network-related control signaling. Such data call performance testing may eventually provide for results both for terminal performance and network performance (particularly, for air interface performance/quality), relating to packet data performance and/or signaling performance. As mentioned herein, a terminal may be any device or module/component of a device, which is capable of using a mobile data service, i.e. a mobile (broadband) data service via an air interface towards network equipment, including any kind of mobile station, user equipment, cell phone, smartphone, phablet, laptop, tablet, or any other kind of mobile unit.

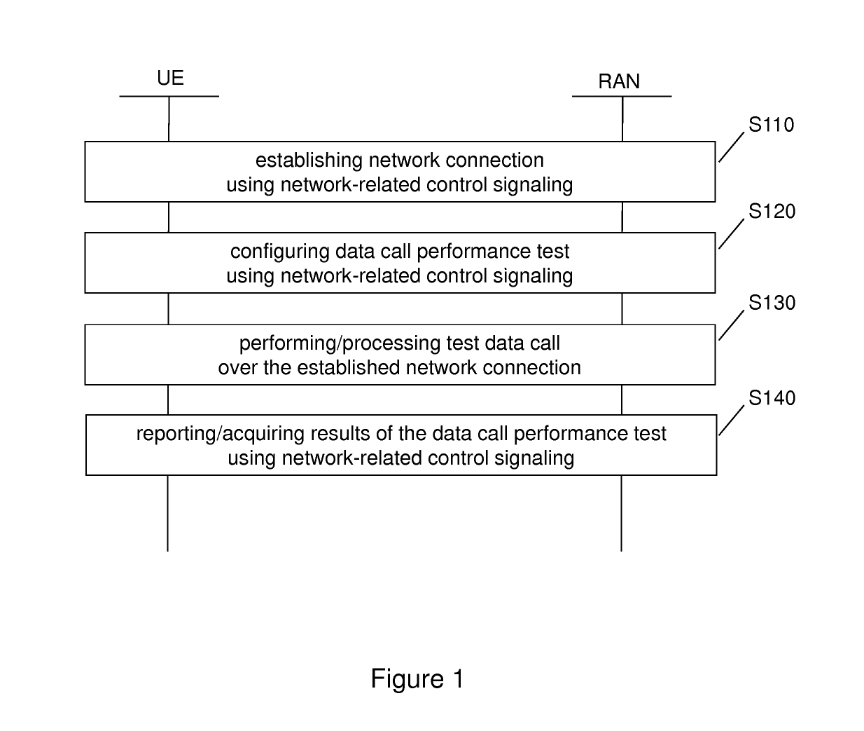

FIG. 1 shows a schematic diagram illustrating a first example of a procedure according to exemplifying embodiments of the present invention. The thus illustrated procedure is operable between at least one terminal, as denoted by UE, and a radio access network entity such as BTS, (e)NodeB, BSC, RNC, or the like, as denoted by RAN.

As illustrated in FIG. 1, a procedure (or method) according to exemplifying embodiments of the present invention basically comprises operations of network connection establishment (S110), data call performance test configuration (S120), test data call execution and data call performance testing (S130) and data call performance test results handling (S140).

In operation S110, a network connection is established between the RAN entity and the terminal for a data call performance test using network-related control signaling. More specifically, both the RAN entity and the terminal respectively establish a mutual network connection for a data call performance test using network-related control signaling. In operation S120, the data call performance test is configured at the terminal using network-related control signaling. More specifically, the RAN entity configures the data call performance test for the terminal at the terminal using network-related control signaling, and the terminal configures the data call performance test using network-related control signaling from the RAN entity. In operation S130, a test data call is executed between the RAN entity and the terminal over the established network connection, and data call performance testing is executed on the basis of the test data call. More specifically, the terminal (initiates and) performs the test data call to the RAN entity over the established network connection, and performs data call performance testing for the test data call, and the RAN entity processes the test data call from the terminal over the established network connection (and may also perform data call performance testing for the test data call). In operation S140, results of the data call performance test for the terminal are reported and acquired using network-related control signaling. More specifically, the terminal reports results of the data call performance test to the RAN entity using network-related control signaling, and the RAN entity acquires results of the data call performance test for the terminal from the terminal using network-related control signaling (and potentially also acquires local measured results of the data call performance test for the terminal).

According to exemplifying embodiments of the present invention, the network-related control signaling may be any network control signaling depending on the underlying standard. In LTE and WCDMA systems, the network-related control signaling may comprise L3 signaling such as e.g. RRC signaling, as exemplified below.

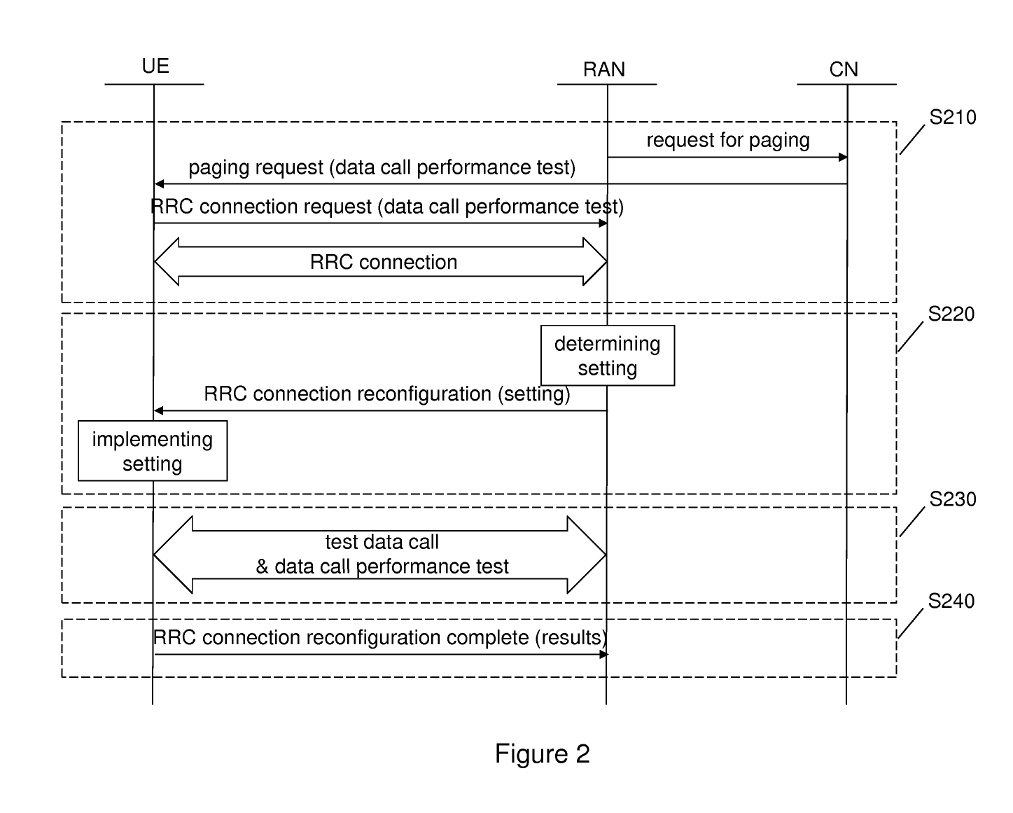

FIG. 2 shows a schematic diagram illustrating a second example of a procedure according to exemplifying embodiments of the present invention. The thus illustrated procedure is operable between at least one terminal, as denoted by UE, and a radio access network entity such as BTS, (e)NodeB, BSC, RNC, or the like, as denoted by RAN, in cooperation with a core network entity, such as MME, MSC, MGW, SGSN, GGSN, SGW, or the like, as denoted by CN.

In FIG. 2, the basic operations of network connection establishment (S210), data call performance test configuration (S220), test data call execution and data call performance testing (S230) and data call performance test results handling (S240) are indicated by dashed boxes.

As illustrated in FIG. 2, in the operation of network connection establishment, the RAN entity may initiate paging of the terminal via a CN entity. Paging may be initiated by a request using a (RAN- or RAT-specific) CP protocol message, such as e.g. a dedicated S1AP message, which may be based on the IMSI or IMEI number of the terminal and/or a specific subscriber profile notification flag, or the like. Upon such request, the CN entity may page the terminal as requested in case it is under the same tracking area or serve area. In the paging request message, the CN entity may indicate that that the paging is related to a data call performance test. Upon receipt of such paging request message, the terminal may issue a connection request message, such as a RRC connection request message, to the RAN entity, indicating that the requested network connection is related to a data call performance test. Such indication may for example be provided by way of a dedicated cause value in a RRC connection request message. Then, the RAN entity may process the connection request message, such as the RRC connection request, indicating that the requested network connection is related to a data call performance test, and the requested network connection, such as the requested RRC connection, may be established between the terminal and the RAN entity.

According to exemplifying embodiments of the present invention, the specific subscriber profile notification flag is generally used for identifying/designating terminals or subscribers with a special (mostly, superior) subscription for a special (mostly, better) service, and may have the following properties. The specific subscriber profile notification flag may mark a special user profile and/or a call of a terminal or subscriber with special user profile. It can be included in L3 (e.g. RRC) signaling for special subscribers or special terminals, such as for important/VIP subscribers, test terminals, friendly users, demo terminals, or the like. More specifically, a CN entity may be able to mark a new call (to be established), e.g. for VIP/friendly users or test terminals, with the special subscriber profile notification flag (e.g. aside traditional QCI information) when a bearer is (to be) set up, and a RAN entity may be able to handle the special subscriber profile notification flag, e.g. to use the flag for creating separate PM counters for different subscriber profiles or by using the subscriber profile information in its radio resource management algorithms, and pass it to a neighbor RAN entity in case of a handover. Such marking can also be used for diagnostics purposes, so that for important/VIP subscribers special attention is paid in dropped call or KPI analysis, and e.g. poor coverage problems can be solved proactively from operator side. Also, when the user profiles are visible in L3 signaling, the results can be collected in an automated way over the whole network either as PM counters or by tracing L3 signaling. This enables comparing the efficiency of different radio resource management algorithms used for different user profiles.

That is, the specific subscriber profile notification flag may be used for identifying/designating special terminals, including terminals dedicated for terminal performance testing, rather than using IMSI or IMEI number of the terminal. Since no IMSI or IMEI number of the terminal is needed, the subscriber or terminal integrity is not risked, and the test results can be analyzed directly from a RAN entity, such as a LTE BTS or the like, where the IMSI or IMEI number of the terminal is usually not even visible. When calls are marked with the specific subscriber profile notification flag, the RAN entity, such as the LTE BTS or the like, can use information in its radio resource management algorithms for providing better service for such terminals, such as important/VIP subscribers or friendly users, or for testing different algorithms (i.e. applying different testing models) for test terminals or demo terminals. In case of test models, the specific subscriber profile notification flag can represent an indication that it is possible to start a test model for certain terminals or subscribers, such as a badly behaving terminal, even without complaints from the end user, in case the specific subscriber profile notification flag indicates that the terminal in question is or represents an important/VIP subscriber or a friendly user.

As illustrated in FIG. 2, in the operation of data call performance test configuration, the RAN entity may configure the data call performance test for the terminal by determining a setting for the data call performance test, and signaling the setting for the data call performance test to the terminal in a connection reconfiguration message, such as a RRC connection reconfiguration message. Then, the terminal may receive the setting for the data call performance test from the RAN entity in the connection reconfiguration message, such as the RRC connection reconfiguration message, and may configure the data call performance test by implementing the setting for the data call performance test. According to exemplifying embodiments of the present invention, the setting for the data call performance test may comprise a setting of one or more of at least one (standardized or predefined) test model, at least one terminal to be tested, at least one terminal model, at least one traffic model for a test data call, source and/or target for a test data call, protocol for a test call, a bearer for a test call, and at least one test parameter. Generally, the data call performance test may be (set to) run both parallel to/on/as an existing bearer or call or to/on/as a new bearer or call to be set up accordingly. Such setting may be based on a higher level testing configuration.

As illustrated in FIG. 2, in the operation of data call performance testing, the terminal may initiate and perform a test data call over the established network connection towards the RAN entity, which is in accordance with the implemented setting for the data call performance test. Such test data call may contain predefined contents, may be based on a set protocol (such as e.g. ping, UDP, FTP, streaming, etc.), may be addressed/destined to the RAN entity, another RAN entity, or another terminal, and so on. The RAN entity may process the test data call over the established network connection from the terminal accordingly. For example, the RAN entity may serve as a data test (model) server/entity to which the test data call is addressed/destined, may route the test data call to another terminal (in its service or coverage area), or may (e.g. in a mobility situation/event) perform a handover of the test data call to another RAN entity, as appropriate. In the former case, the RAN entity may terminate the test data call, and has to have or support data analyzer/receiver functionality (of the data test (model) server/entity). In the latter cases, the RAN entity forwards the test data call (to or, at least, via a data test (model) server/entity), and does not have to have or support such data analyzer/receiver functionality itself; rather, such data analyzer/receiver functionality is included in a data test (model) server/entity (which is not illustrated, but can be implemented e.g. in the terminal, another RAN entity, some dedicated/separate element, or the like). The data call performance testing may then be performed on the basis of the test data call. That is, set test parameters may be grasped e.g. by way of measurement, detection, etc. at the terminal (and/or the RAN entity).

In an example, a BTS may signal, in RrcConnectionReconfiguration, test model data call bearer parameters, test model data call generator type and data sending and receiving pattern, e.g. data call QCI and maximum transmitted data amount for UL/DL directions, and test model duration. Also, in RrcConnectionReconfiguration or its NAS container, destination IP address information, where to send and receive data packets in the test data call, and the used protocol for carrying them (e.g. ping, UDP, FTP, streaming) may be included. In case the destination is an UE instead of a data test (model) server, also the MSIDN/IMSI number of the destination UE may be included. The BTS may decide the test model source and target destinations, e.g. whether the test model is configured between a terminal and a data test (model) server, according to a higher level configuration. In case of mobility, the BTS may inform in the HO signaling the target network element that the handed-over bearer or call is related to data call performance testing. After the data call performance testing is completed, the UE may report, in RrcConnectionReconfigurationComplete, the data rate, PRB allocation, BER and CQI average information with test model duration and HO information. Also, average, minimum and/or maximum results in terms of power control, e.g. UE power control results (2G), UE power control specific path loss (LTE) and UE SIR target (WCDMA), may be included in RrcConnectionReconfigurationComplete.

Although not illustrated in FIG. 2, the RAN entity may (instruct to) stop, cancel or abort the data call performance test (and the associated test data call). This may be accomplished by way of a connection reconfiguration message to the terminal, e.g. a RRC connection reconfiguration message. Thus, the RAN entity may (instruct to) stop, cancel or abort the data call performance test (and the associated test data call), even before lapse of a set test duration or in case no test duration is set, when a specific situation or event occurs, e.g. sufficient test data is collected, test processing is no longer possible due to low energy state, high processing load, etc., and so on.

As illustrated in FIG. 2, in the operation of data call performance test results handling, the terminal may report results of the data call performance test using by signaling the results to the RAN entity in a connection reconfiguration complete message, such as a RRC connection reconfiguration complete message. The RAN entity may acquire results of the data call performance test using by receiving the results from the terminal in the connection reconfiguration complete message, such as the RRC connection reconfiguration complete message. Additionally or alternatively, the RAN entity may acquire results of the data call performance test using by locally grasping such results by way of measurement, detection, etc. According to exemplifying embodiments of the present invention, the results may comprise one or more of data rate, bit error rate (BER), channel quality indicator (CQI) information, handover (HO) information, physical resource block (PRB) allocation, terminal power control specific path loss information, terminal signal-to-interference ratio (SIR) target information, and test duration. Specifically, UE power control specific path loss may be used as a terminal performance result in LTE and LTE-A, and UE SIR target may be used as a terminal performance result in WCDMA, for example. For these results, average, minimum and/or maximum values may be used.

In view of the above, according to exemplifying embodiments of the present invention, a RAN entity, such as BTS, (e)NodeB, BSC, RNC, or the like, may start/initiate data call performance testing for one or more terminals.

Although not illustrated in FIG. 2, in starting/initiating data call performance testing, the RAN entity may also notify the one or more terminals to be tested accordingly. Namely, the RAN entity may inform any terminal (i.e. its user) that its data call performance is intended to be tested, or the RAN entity may inquire acceptance for the intended data call performance testing from any terminal (i.e. its user) when such intended data call performance testing needs to be approved. In the latter case, the intended data call performance testing may be cancelled in the absence of a user's approval (within a predetermined time period) or in case of user's denial. Such notification may be accomplished by any mechanism applicable between the terminal and the RAN entity, such as by SMS.

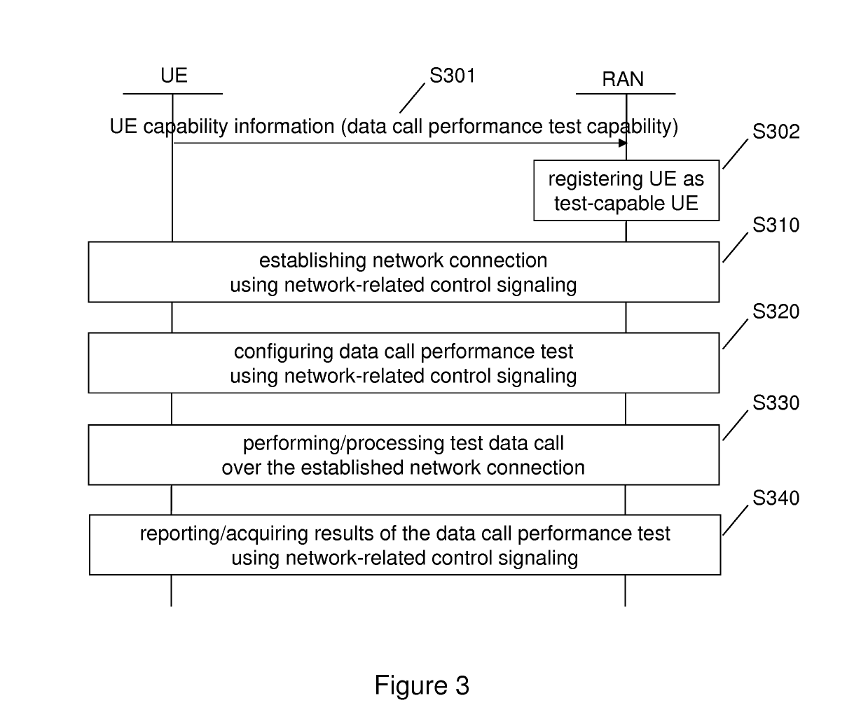

FIG. 3 shows a schematic diagram illustrating a third example of a procedure according to exemplifying embodiments of the present invention.

As illustrated in FIG. 3, a procedure (or method) according to exemplifying embodiments of the present invention may comprise an operation of terminal testing capability verification prior to the above-described operations of network connection establishment (S310), data call performance test configuration (S320), test data call execution and data call performance testing (S330) and data call performance test results handling (S340).

As illustrated in FIG. 3, in the operation of terminal testing capability verification, the terminal may report terminal capability parameters indicating data call performance test capability of the terminal to the RAN entity (S301). Upon acquisition of the terminal capability parameters indicating data call performance test capability of the terminal, the RAN entity may register the terminal with data call performance test capability on the basis of the acquired terminal capability parameters (S302), e.g. as a test-capable UE.

Such data call performance test capability may represent support for handling (standardized or predefined) data call performance tests (or, data call performance test models). The reporting/signaling thereof may be accomplished in UE radio capability parameters. The reporting and registering operations described here are inherently independent of the subsequent operations for data call performance testing. That is, the reporting and registering operations may take place at any time, not only in the context or as direct preparation for data call performance testing.

In the above-outlined manner, the RAN entity may register a plurality of terminals as test-capable UEs (e.g. many or even all terminals in its service or coverage area), and may perform the subsequent operations based on such registering. For example, the RAN entity may start/perform a data call performance test only for one or more terminals having corresponding data call performance test capability. More specifically, the RAN entity may select one or more terminals to be tested, and may initiate paging of the terminal via a CN entity, as described above, only for selected UEs, and the CN entity may page only such one or more terminals exhibiting corresponding capabilities, i.e. such UEs having proper testing criteria.

Based on such registering, the RAN entity may distinguish between terminals of different categories, i.e. between UE categories with and without data call performance test capability. Hence, according to exemplifying embodiments of the present invention, a RAN entity, such as BTS, (e)NodeB, BSC, RNC, or the like, may start/initiate data call performance testing for one or more test-capable terminals accordingly.

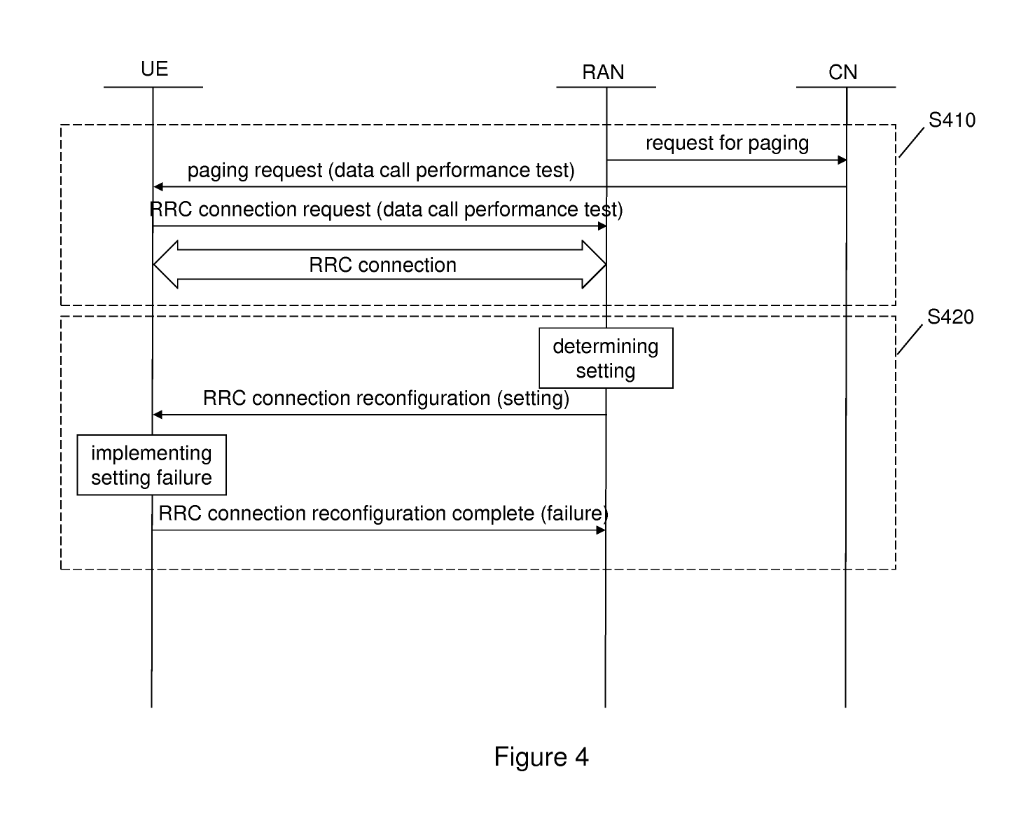

FIG. 4 shows a schematic diagram illustrating a fourth example of a procedure according to exemplifying embodiments of the present invention.

As shown in FIG. 4, a procedure (or method) according to exemplifying embodiments of the present invention may comprise a failure in the configuration of the data call performance test, i.e. in operation S420 basically corresponding to operation S120, S220 and S320 in FIGS. 1, 2 3, respectively.

Namely, there may be case in which the network-configured/controlled data call performance test may not be configured/implemented at the terminal to be tested, e.g. due to the lack of necessary data call performance test capability, low energy state, high processing load, installation of a certain (incapable) operating system, or the like. That is, the terminal may check whether it is able/allowed to implement the instructed/configured data call performance test on the basis of certain criteria. In such case, the terminal may inform the RAN entity accordingly, e.g. by way of a failure indication in a connection reconfiguration complete/failure message, such as a RRC connection reconfiguration complete/failure message. Such failure indication may also indicate the reason why the instructed/configured data call performance test could not be implemented.

According to exemplifying embodiments of the present invention, the procedure of any one of FIGS. 1 to 4 may be performed when the RAN entity is in a test-dedicated state for performance testing of the RAN entity. Namely, the RAN entity itself may be in a test dedicated state, and thus it shall be able to independently start data call performance testing, page one or more (selected) UEs, and process the test data call. In the test dedicated state, a setting for the data call performance test, including e.g. UE test models and paged UE, may be configured via a management interface of the RAN entity, e.g. a BTS Manager GUI, similar to settings for the performance testing of the RAN entity itself. Thereby, it may also be set whether the RAN entity shall (be enabled to) act as a packet data test (model) server, or only support packet data signaling between UEs. When only support for packet data signaling is set, the RAN entity does not have to have or support possibly complicated data analyzer/receiver functionality. Thereby, RAN entity testing (e.g. in a testing (laboratory) environment) and UE testing (e.g. in a lice network environment) may be combined.

According to exemplifying embodiments of the present invention, (standardized or predefined) test models for terminal data call performance testing may be performed by network control using network-related control signaling (between a controlling RAN entity and a controlled terminal).

Such (standardized or predefined) test models for terminal data call performance testing, which are thus controllable according to exemplifying embodiments of the present invention, are capable of providing for technical effects and benefits in various use cases, as exemplarily outlined hereinafter.

When a subscriber calls an operator's customer service center and complaints about poor performance, e.g. throughput or breaking calls, the operator can run a set of (predefined or standardized) data call test models for the terminal of the subscriber. Accordingly, data call performance testing based on appropriate (predefined or standardized) data call test models can be accomplished via the radio access network of the operator. Thereby, the prevailing (actual/real) signal/propagation conditions, as well as network and terminal performance can be verified. With (predefined or standardized) data call test models, the operator can quickly rule out higher level causes related to problems in the terminal, network or signal conditions, without a need for sending anyone into the field. Thus, troubleshooting is improved for the operator.

If a suboptimal power control parameter (in the radio access network) is suspected, data test calls for data call performance testing (under (predefined or standardized) data call test models) can be run for the same terminal or a set of terminals with different power control parameters: Then, own and neighbor cell UP and CP KPIs can be compared for analyzing the optimal power control results. In particular, such data call performance testing can be run in a live network environment, e.g. with dedicated test terminals, without a need for reconfiguring the cells.

When network control of data call performance testing is implemented using network-related control signaling, as exemplified above, usage of principles of the present invention and its exemplifying embodiments is visible in S1AP and RRC signalling, e.g. when UE radio capability parameters are introduced, and is visible in RRC signalling and CN CP signaling, when testing is started and/or ended accordingly. When power control parameters are visible in the network-related control signaling such as L3 signaling, the results can be collected in automated way over the whole network either as PM counters or by tracing the network-related control signaling such as L3 signaling.

If it is expected that there are problems in terminal capability in handling either LTE path loss measurement, WCDMA SIR target or power control algorithm, or the like, different terminal models used in data call performance testing (under (predefined or standardized) data call test models) and compared for power control results, e.g. in a live network environment, when the used traffic type is standardized and the terminal reports measured path loss and/or SIR target. Different traffic models also help in ruling out problems, which are related to specific idle/active periods between allocated data and control channels. This is because the RAN-side power control algorithms typically are highly depending on how often certain channels are scheduled.

That is, when there are problems in terminal operation/behavior, it is enabled/facilitated to pinpoint the actual cause for such problems within the overall system deployment, i.e. whether the problem is caused by signal conditions, network performance problems, terminal performance problems, or the like. For example, if there are suspected problems in power control, it is enabled/facilitated to say whether the problem is caused by terminal inaccuracy to handle the terminal side of power control suboptimal power control parameters, and/or by suboptimal power control algorithms in the RAN, e.g. at the BTS or RNC, and/or by bugs in the handling of the RAN side of power control. Specifically, data call performance testing (under (predefined or standardized) data call test models) can be expanded to live network level, instead of running them only at a single RAN entity in a testing (e.g. laboratory) environment. Thus, better diagnostic capabilities, both for terminal testing and network testing (particularly, for air interface performance testing), are provided on the network side, i.e. a RAN entity.

It is beneficial that a terminal to be tested does not need to have a test/controlling PC, as mentioned above, e.g. for generating test traffic, which makes the test set-up simpler and cheaper, and enables that any terminal can be tested, even without previously installing specific test hardware and/or software thereon. Further, it is beneficial that terminals to be tested are easier to be deployed into different locations, as they do not need a test/controlling PC. For example, the operator can make a deal with a local taxi company (sharing test terminals among the taxi drivers) or share test terminals among its employees to be carried or kept e.g. at home, for getting needed geographical test terminal coverage. The only thing needed is a small charger and that the test terminals are able to run the test models, preferably continuously. When the data call test model can be set up in a test dedicated state of a RAN entity, it enables easier combined laboratory testing with terminal and RAN entity. Still further, it is beneficial that no core network or core network simulator and no call generator is actually needed for testing purposes, which makes test set-ups cheaper and simpler. Thus, benchmarking of terminal/user UP call performance and/or power control accuracy of different terminal models is enabled/facilitated.

It is to be noted that exemplifying embodiments of the present invention generally relate to data call performance testing, including packet data performance and signaling performance.

While the foregoing description mainly refers to data call performance testing relating to packet data performance, data call performance testing relating to signaling performance is equally applicable within the above-described concepts. Namely, exemplifying embodiments of the present invention equally cover a case in which CP signaling is tested in a network-controlled manner, i.e. when packet data performance as such is not relevant. Such signaling performance testing is effective. This is because for data calls (i.e. packet data communication) signaling causes more load than in fro voice calls (i.e. connection-switched communication), since the terminal applications are often sending just a few polling bytes, which require a lot of signaling but not that much UP resources.

Accordingly, the data call performance test may be configured such that no specific packet data (i.e. application data) is communicated in the test data call, and signaling performance is tested rather than data communication performance. To this end, a data call test model may be a signaling test model for testing e.g. a RAN entity's capability to handle signaling load, a terminal's signaling response times, measurement report accuracy, and network signal conditions.

The signaling test model is configured to trigger a certain kind of signaling between the terminal and the RAN entity. It may be such the RAN entity, such as BTS, (e)NodeB, RNC or BSC, or the like, sends different kinds of signaling commands related to bearer handling and measurement reports to the terminal, to which the terminal replies according to the way defined in the applicable standard, such as for L3 (e.g. RRC) signaling. The RAN entity shall be able to signal and configure the data call test model for the terminal. The data used in the test data call for a signaling test model is dummy data, which can be generated at the RAN entity and/or the terminal. The dummy data shall preferably be used only when it is needed for carrying out the signaling scenario of the test data call, and it is terminated at the receiving side directly after L2 processing and is neither forwarded nor analyzed, thereby keeping the implementation simpler than for packet data performance testing. In this regard, determining and implementing a setting for signaling performance testing, actual signaling performance testing in the test data call, result acquisition/reporting, capability information acquisition/reporting, and the like is effected for signaling performance testing in correspondence with what is described above in general terms and/or for packet data performance testing. That is, the concepts described in connection with FIGS. 2 to 4 apply accordingly.

By way of signaling performance testing according to exemplifying embodiments of the present invention, paging, control channel, and protocol load testing can be accomplished, both in live network environment and testing (e.g. laboratory) environment, with simple setup. In this regard, a control channel may for example be RACH, PUCCH, PDCCH, or the like, and a protocol may be RRC, or the like. The only things needed are a corresponding test model supporting terminals to be located under the test RAN entity area, and their identification information for starting the test model. Also, different terminal types can be compared against CP performance, e.g. latency to reply to signaling or ability to measure and report accurately own and neighbor cell signal levels. The terminals in test can be used as smart antennas in the radio access network. For example, in important cells, test terminals can be configured, which report periodic measurements via test models all the time for DL signal conditions from own and neighbor cells, for detecting possible poor DL signal conditions or abnormal DL interference.

By virtue of exemplifying embodiments of the present invention, as evident from the above, network-controlled terminal data call performance testing, e.g. controlling terminal data call performance testing using network-related control signaling (e.g. dedicated signaling messages and/or parameters), can be enabled/realized. Thus, terminal data call performance testing (potentially combined with network data call performance testing) can be improved, particularly in a live network environment.

Generally speaking, exemplifying embodiments of the present invention provide for a solution to run single- or multi-bearer data call performance tests (including (semi-) automatic control of testing procedures) in both live network and testing environments, requiring minimal additional testing equipment/arrangements. Hence, objective performance/quality testing based on a real-life test data call from the terminal to be tested and call data analyzing (which may be referred to as an intrusive test approach) using network-related control signaling for controlling testing procedures is provided.

As evident from the above, data call performance testing (under (predefined or standardized) data call test models) can be started from a network side for a terminal for measuring test parameters such as BER, CQI and data rates. The terminal in test reports test parameter measurements, such as average, minimum and/or maximum results in terms of power control, e.g. UE power control results (2G), UE power control specific path loss (LTE) and UE SIR target (WCDMA), to the network side. The testing can be run in network-side call processing without a need for a core network or a core network simulator by configuring identification information of the terminal in test, such as a test UE's MSISDN/IMSI information. In data call performance testing (under (predefined or standardized) data call test models), the terminal in test starts a (predefined) test data call either to another terminal (via a RAN entity) or to a dedicated data call test (model) server (e.g. the RAN entity). In this regard, a RAN entity on the network side is able to signal and configure the data call performance testing (under (predefined or standardized) data call test models) for the terminal.

As mentioned above, it is very difficult to estimate throughput performance of terminals, unless the higher level application behavior and the used protocol (e.g. TCP streaming) are known. Accordingly, exemplifying embodiments of the present invention teach to utilize predefined or standardized data call test models (e.g. including predefined or standardized test applications) using predefined or standardized higher level application behavior (e.g. including specified application data to be communicated in the test data call) and protocol. Thereby, the results of terminal performance testing become comparable across different cells and different networks. For example, a test application may be predefined or standardized to try establishing a 20 Mbps streaming connection or opening certain test webpages as quickly as possible, and the terminal performance may be derived as a result of such predefined or standardized test.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, network nodes and/or systems, including both software and/or hardware thereof.

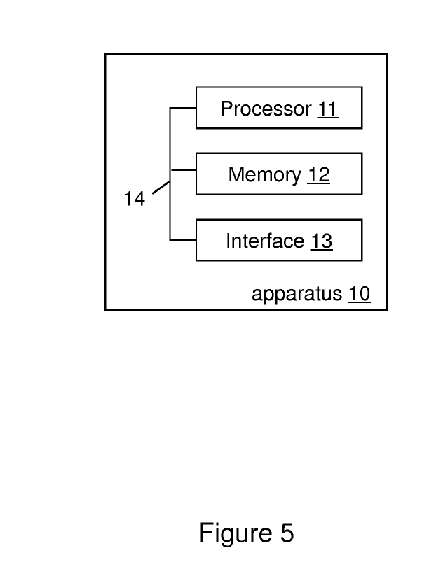

Respective exemplifying embodiments of the present invention are described below referring to FIG. 5, while for the sake of brevity reference is made to the detailed description of respective corresponding configurations/setups, schemes, methods and functionality, principles and operations according to FIGS. 1 to 4.

In FIG. 5, the blocks are basically configured to perform respective methods, procedures and/or functions as described above. The entirety of blocks are basically configured to perform the methods, procedures and/or functions as described above, respectively. With respect to FIG. 5, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIG. 5, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 5 shows a schematic diagram illustrating an example of a structure of apparatuses according to exemplifying embodiments of the present invention.

As indicated in FIG. 5, according to exemplifying embodiments of the present invention, an apparatus 10 may comprise at least one processor 11 and at least one memory 12 (and possibly also at least one interface 13), which may be operationally connected or coupled, for example by a bus 14 or the like, respectively.

The processor 11 and/or the interface 13 of the apparatus 10 may also include a modem or the like to facilitate communication over a (hardwire or wireless) link, respectively. The interface 13 of the apparatus 10 may include a suitable transmitter, receiver or transceiver connected or coupled to one or more antennas, antenna units, such as antenna arrays or communication facilities or means for (hardwire or wireless) communications with the linked, coupled or connected device(s), respectively. The interface 13 of the apparatus 10 is generally configured to communicate with at least one other apparatus, device, node or entity (in particular, the connector thereof).

The memory 12 of the apparatus 10 may represent a (non-transitory/tangible) storage medium and store respective software, programs, program products, macros or applets, etc. or parts of them, which may be assumed to comprise program instructions or computer program code that, when executed by the respective processor, enables the respective electronic device or apparatus to operate in accordance with the exemplifying embodiments of the present invention. Further, the memory 12 of the apparatus 10 may (comprise a database to) store any data, information, or the like, which is used in the operation of the apparatus.

In general terms, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 10 is suitable for use in practicing one or more of the exemplifying embodiments of the present invention, as described herein.

When in the subsequent description it is stated that the processor (or some other means) is configured to perform some function, this is to be construed to be equivalent to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function.

On the one hand, the thus illustrated apparatus 10 may represent or realize/embody a (part of a) RAN entity. Specifically, the thus illustrated apparatus 10 may be configured to perform a procedure and/or exhibit a functionality as described, for the RAN entity, in any one of FIGS. 1 to 4.

Accordingly, the apparatus 10 may be caused or the apparatus 10 or its processor 11 (possibly together with computer program code stored in the memory 12), in its most basic form, is configured to perform or cause establishing a network connection with at least one terminal for a data call performance test using network-related control signaling, configuring the data call performance test for a terminal at the terminal using network-related control signaling, processing a test data call from the terminal over the established network connection, and acquiring results of the data call performance test for the terminal from the terminal using network-related control signaling.

On the other hand, the thus illustrated apparatus 10 may represent or realize/embody a (part of a) terminal. Specifically, the thus illustrated apparatus 10 may be configured to perform a procedure and/or exhibit a functionality as described, for the UE, in any one of FIGS. 1 to 4.

Accordingly, the apparatus 10 may be caused or the apparatus 10 or its processor 11 (possibly together with computer program code stored in the memory 12), in its most basic form, is configured to perform or cause establishing a network connection with at least one radio access network entity for a data call performance test using network-related control signaling, configuring the data call performance test using network-related control signaling from the radio access network entity, performing a test data call to the radio access network entity over the established network connection, and reporting results of the data call performance test to the radio access network entity using network-related control signaling.

As mentioned above, any apparatus according to exemplifying embodiments of the present invention may be structured by comprising respective means for performing corresponding operations, procedures and/or functions. For example, such means may be implemented/realized on the basis of an apparatus structure, as exemplified in FIG. 5, i.e. by one or more processors 11, one or more memories 12, one or more interfaces 13, or any combination thereof.

An apparatus, which is operable as or represents/realizes/embodies a (part of a) RAN entity, may comprise means for establishing a network connection with at least one terminal for a data call performance test using network-related control signaling, means for configuring the data call performance test for a terminal at the terminal using network-related control signaling, means for processing a test data call from the terminal over the established network connection, and means for acquiring results of the data call performance test for the terminal from the terminal using network-related control signaling.

An apparatus, which is operable as or represents/realizes/embodies a (part of a) terminal, may comprise means for establishing a network connection with at least one radio access network entity for a data call performance test using network-related control signaling, means for configuring the data call performance test using network-related control signaling from the radio access network entity, means for performing a test data call to the radio access network entity over the established network connection, and means for reporting results of the data call performance test to the radio access network entity using network-related control signaling.

For further details regarding the operability/functionality of the individual apparatuses (or means thereof) according to exemplifying embodiments of the present invention, reference is made to the above description in connection with any one of FIGS. 1 to 4, respectively.

According to exemplifying embodiments of the present invention, any one of the processor, the memory and the connector, as well as any one of the means, may be implemented as individual modules, chips, chipsets, circuitries or the like, or one or more of them can be implemented as a common module, chip, chipset, circuitry or the like, respectively.

According to exemplifying embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling/realizing network-controlled terminal data call performance testing, e.g. controlling terminal data call performance testing using network-related control signaling. Such measures exemplarily comprise establishment of a network connection between a radio access network entity and at least one terminal for a data call performance test using network-related control signaling, configuration of the data call performance test at the terminal using network-related control signaling, execution of a test data call between the radio access network entity and the at least one terminal over the established network connection, and report and acquisition of results of the data call performance test for the terminal using network-related control signaling.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

List of Acronyms and Abbreviations

| | |
|---|---|
| 3GPP | 3rd Generation Partnership Project |
| BER | Bit Error Rate |
| BSC | Base Station Controller |
| BTS | Base Transceiver Station |
| CN | Core Network |
| CP | Control Plane |
| CQI | Channel Quality Indicator |
| DL | Downlink |
| FTP | File Transfer Protocol |
| GGSN | Gateway GPRS Support Node |
| GPRS | General Packet Radio Service |
| GUI | Graphical User Interface |
| HO | Handover |
| IMEI | International Mobile Equipment Identity |
| IMSI | International Mobile Subscriber Identity |
| KPI | Key Performance Indicator |
| L3 | Layer 3 of OSI reference model |
| LTE | Long Term Evolution |
| LTE-A | Long Term Evolution Advanced |
| MGW | Media Gateway |
| MME | Mobility Management Entity |
| MSC | Mobile Switching Center |
| MSISDN | Mobile Station Integrated Services Digital Network Number |
| NAS | Non-Access Stratum |
| OLPC | Outer Loop Power Control |
| PC | Personal Computer |
| PDCCH | Physical Downlink Control Channel |
| PM | Performance Measurement |
| PRB | Physical Resource Block |
| PUCCH | Physical Uplink Control Channel |
| QCI | Quality Class Indicator |
| RACH | Random Access Channel |
| RAN | Radio Access Network |
| RAT | Radio Access Technology |
| RNC | Radio Network Controller |
| RRC | Radio Resource Control |
| S1AP | S1 Application Protocol |
| SGSN | Serving GPRS Support Node |
| SGW | Serving Gateway or Service Gateway |
| UDP | User Datagram Protocol |
| UE | User Equipment |
| UL | Uplink |
| UP | User Plane |
| WCDMA | Wideband Code Division Multiple Access |

1. A method comprising
establishing a network connection with at least one terminal for a data call performance test using network-related control signaling,
configuring the data call performance test for a terminal at the terminal using network-related control signaling,
processing a test data call from the terminal over the established network connection, and
acquiring results of the data call performance test for the terminal from the terminal using network-related control signaling.

2. The method according to claim 1, further comprising:
acquiring terminal capability parameters indicating data call performance test capability, and
registering terminals with data call performance test capability on the basis of the acquired terminal capability parameters.

3. The method according to claim 1, wherein establishing the network connection comprises
initiating paging of at least one terminal with data call performance test capability via a core network entity using a control plane protocol message, and
processing a connection request message indicating that the requested network connection is related to a data call performance test.

4. The method according to claim 1, wherein configuring the data call performance test for the terminal comprises:
determining a setting for the data call performance test, including a setting of one or more of at least one predefined test model, at least one terminal to be tested, at least one terminal model, at least one traffic model for the test data call, source and/or target for the test data call, protocol for the test call, a bearer for the test call, and at least one test parameter, and
signaling the setting for the data call performance test to the terminal in a connection reconfiguration message.

5. The method according to claim 1, wherein processing the test data call comprises at least one of routing the test data call to a destination terminal, handing over the test data call to another network element, and terminating the test data call.

6. The method according to claim 1, wherein
acquiring results of the data call performance test comprises receiving the results from the terminal in a connection reconfiguration complete message, and/or
the data call performance test relates to at least one of packet data performance and signaling performance, and/or
the results comprise one or more of data rate, bit error rate, channel quality indicator information, handover information, physical resource block allocation, terminal power control specific path loss information, terminal signal-to-interference ratio target information, and test duration.

7. (canceled)

8. (canceled)

9. A method comprising
establishing a network connection with at least one radio access network entity for a data call performance test using network-related control signaling,
configuring the data call performance test using network-related control signaling from the radio access network entity,
performing a test data call to the radio access network entity over the established network connection, and
reporting results of the data call performance test to the radio access network entity using network-related control signaling.

10. The method according to claim 9, further comprising:
reporting terminal capability parameters indicating data call performance test capability to the radio access network entity.

11. The method according to claim 9, wherein establishing the network connection comprises
receiving a paging request from a core network entity, indicating that the paging is related to a data call performance test, and
issuing a connection request message to the radio access network entity, indicating that the requested network connection is related to a data call performance test.

12. The method according to claim 9, wherein configuring the data call performance test comprises:
receiving a setting for the data call performance test from the radio access network entity in a connection reconfiguration message, including a setting of one or more of at least one predefined test model, at least one terminal to be tested, at least one terminal model, at least one traffic model for the test data call, source and/or target for the test data call, protocol for the test call, a bearer for the test call, and at least one test parameter, and
implementing the setting for the data call performance test.

13. (canceled)

14. The method according to claim 9, wherein
reporting results of the data call performance test comprises signaling the results to the radio access network entity in a connection reconfiguration complete message, and/or
the data call performance test relates to at least one of packet data performance and signaling performance, and/or
the results comprise one or more of data rate, bit error rate, channel quality indicator information, handover information, physical resource block allocation, terminal power control specific path loss information, terminal signal-to-interference ratio target information, and test duration.

15. The method according to claim 9, wherein
the method is operable at or by at least one terminal subject to the data call performance test, and/or
the radio access network entity comprises one or more of a base station, a base station controller and a radio network controller, and/or
the network-related control signaling comprises radio resource control signaling.

16.-23. (canceled)

24. An apparatus comprising
a processor, and
a memory configured to store computer program code,
wherein the processor is configured, in response to execution of the computer program code, to cause the apparatus to perform:
establishing a network connection with at least one radio access network entity for a data call performance test using network-related control signaling,
configuring the data call performance test using network-related control signaling from the radio access network entity,
performing a test data call to the radio access network entity over the established network connection, and
reporting results of the data call performance test to the radio access network entity using network-related control signaling.

25. The apparatus according to claim 24, wherein the processor is configured, in response to execution of the computer program code, to cause the apparatus to perform:
reporting terminal capability parameters indicating data call performance test capability to the radio access network entity.

26. The apparatus according to claim 24, wherein the processor is configured, in response to execution of the computer program code, to cause the apparatus to perform:
receiving a paging request from a core network entity, indicating that the paging is related to a data call performance test, and
issuing a connection request message to the radio access network entity, indicating that the requested network connection is related to a data call performance test.

27. The apparatus according to claim 24, wherein the processor is configured, in response to execution of the computer program code, to cause the apparatus to perform:
receiving a setting for the data call performance test from the radio access network entity in a connection reconfiguration message, including a setting of one or more of at least one predefined test model, at least one terminal to be tested, at least one terminal model, at least one traffic model for the test data call, source and/or target for the test data call, protocol for the test call, a bearer for the test call, and at least one test parameter, and
implementing the setting for the data call performance test.

28. (canceled)

29. The apparatus according to claim 24, wherein reporting results of the data call performance test comprises signaling the results to the radio access network entity in a connection reconfiguration complete message, and/or
the data call performance test relates to at least one of packet data performance and signaling performance, and/or
the results comprise one or more of data rate, bit error rate, channel quality indicator information, handover information, physical resource block allocation, terminal power control specific path loss information, terminal signal-to-interference ratio target information, and test duration.

30. The apparatus according to claim 24, wherein
the apparatus is operable as or at at least one terminal subject to the data call performance test, and/or
the radio access network entity comprises one or more of a base station, a base station controller and a radio network controller, and/or
the network-related control signaling comprises radio resource control signaling.

31. A computer program product comprising a non-transitory computer readable medium having computer-executable computer program code which, when the computer program code is executed on a computer, is configured to cause the computer to carry out the method according to claim 1.

32. A computer program product comprising a non-transitory computer readable medium having computer-executable computer program code which, when the computer program code is executed on a computer, is configured to cause the computer to carry out the method according to claim 9.
